(19) United States
(12) Patent Application Publication
(10) Pub. No.: US 2011/0256437 A1
(43) Pub. Date: Oct. 20, 2011

(54) LITHIUM SECONDARY BATTERY POSITIVE ELECTRODE AND LITHIUM SECONDARY BATTERY

(76) Inventors: Toshihiro Katsuki, Osaka (JP); Toshiharu Shimooka, Osaka (JP); Itaru Gosho, Osaka (JP)

(21) Appl. No.: 13/042,081

(22) Filed: Mar. 7, 2011

(30) Foreign Application Priority Data
Apr. 19, 2010 (JP) 2010-095626

(51) Int. Cl. H01M 4/62; H01M 10/36

(52) U.S. Cl. 429/94; 429/217

(57) ABSTRACT

A lithium secondary battery positive electrode of the present invention includes a positive electrode material mixture layer containing a positive electrode active material, a conductivity enhancing agent and a binder on one or both sides of a current collector, and the positive electrode active material contains a lithium-containing composite oxide represented by the general compositional formula: Li₁₊ₓMO₂, where x is in a range of −0.15≦x≦0.15 and M represents an element group of three or more elements including at least Ni, Co and Mn. The binder contains a tetrafluoroethylene-vinylidene fluoride copolymer (P(TFE-VDF)) and polyvinylidene fluoride (PVDF). The total content of the binder in the positive electrode material mixture layer is 1 to 4 mass %, and the ratio of the P(TFE-VDF) is 10 mass % or more, when the total of the P(TFE-VDF) and the PVDF is taken as 100 mass %.

### BACKGROUND OF THE INVENTION

1. Field of the Invention

The present invention relates to a lithium secondary battery having high reliability and good productivity, and a lithium secondary battery positive electrode for forming such a lithium secondary battery.

2. Description of the Related Art

With the recent development of portable electronic devices such as mobile phones and notebook personal computers and the commercialization of electric vehicles, there is an increasing demand for small, lightweight, and high capacity secondary batteries and capacitors.

Conventionally, LiCoO₂ has been widely used as a positive electrode active material for secondary batteries and capacitors. However, to meet the demand for higher capacity as described above, for example, JP 08-106897A describes using, for example, LiNiO₂, which has a higher capacity per volume than that of LiCoO₂, as a positive electrode active material, and forming a secondary battery or capacitor by using a positive electrode including a positive electrode material mixture layer containing the above-mentioned positive electrode active material, a conductivity enhancing agent and a binder such as polyvinylidene fluoride on one or both sides of a current collector.

However, it has been found that when a secondary battery is formed by using a wound electrode assembly that has been formed by laminating a positive electrode using a material having a high Ni ratio, such as LiNiO₂, as a positive electrode active material with a negative electrode and a separator, and then spirally winding the laminate, defects such as cracking can easily occur in the positive electrode material mixture layer especially on the inner circumferential side of the wound electrode assembly, and the reliability and the productivity of the battery tend to be reduced as compared with batteries using LiCoO₂ as the positive electrode active material.

### SUMMARY OF THE INVENTION

Therefore, the present invention has been achieved with the foregoing in mind, and it is an object of the invention to provide a lithium secondary battery having high reliability and good productivity, and a lithium secondary battery positive electrode for forming such a lithium secondary battery.

A lithium secondary battery positive electrode according to the present invention is a lithium secondary battery positive electrode including a positive electrode material mixture layer containing a positive electrode active material, a conductivity enhancing agent and a binder on one or both sides of a current collector, wherein the positive electrode active material contains a lithium-containing composite oxide represented by the general compositional formula: Li₁₊ₓMnO₂, where x is in a range of −0.15≦x≦0.15 and M represents an element group of three or more elements including at least Ni, Co and Mn, the ratios of Ni, Co and Mn to the total elements constituting M satisfy 50≦a≦90, 5≦b≦30, 5≦c≦30, and 10≦b+c≦50 where the ratios of Ni, Co and Mn are represented by a, b and c, respectively, in units of mol %, the binder contains a tetrafluoroethylene-vinylidene fluoride copolymer and polyvinylidene fluoride, the total content of the binder in the positive electrode material mixture layer is 1 to 4 mass %, and the ratio of the tetrafluoroethylene-vinylidene fluoride copolymer is 10 mass % or more, when the total of the tetrafluoroethylene-vinylidene fluoride copolymer and the polyvinylidene fluoride is taken as 100 mass %.

A lithium secondary battery according to the present invention includes a positive electrode, a negative electrode, a separator and a non-aqueous electrolyte, wherein the positive electrode, the negative electrode, and the separator form a wound electrode assembly, and the above-described lithium secondary battery positive electrode of the present invention is used as the positive electrode.

### BRIEF DESCRIPTION OF THE DRAWINGS

FIG. 1A is a plan view showing an example of a lithium secondary battery of the present invention.

FIG. 1B is a cross-sectional view of FIG. 1A.

FIG. 2 is a perspective view of FIG. 1A.

### DESCRIPTION OF THE PREFERRED EMBODIMENTS

As described above, in a battery including a wound electrode assembly that uses a positive electrode using a lithium-containing composite oxide having a high Ni ratio as the positive electrode active material, defects such as cracking can easily occur in the positive electrode material mixture layer especially on the inner circumferential side of the wound electrode assembly, and thus a capacity decrease and the like tend to occur. The reason for this seems to be as follows.

Polyvinylidene fluoride (PVDF) is often used as a binder for a positive electrode material mixture layer of a lithium secondary battery positive electrode. However, the adhesion between a current collector with a positive electrode material mixture layer that has been formed using a lithium-containing composite oxide having a high Ni ratio together with PVDF becomes very high. The reason for this seem to be that a lithium-containing composite oxide having a high Ni ratio usually contains a large amount of alkaline components as impurities, and these alkaline components cause a cross-linking reaction of PVDF, thus increasing the adhesion between the current collector and the positive electrode material mixture layer.

If the adhesion between the current collector and the positive electrode material mixture layer becomes too high, then the positive electrode material mixture layer, which cannot be easily deformed, cannot sufficiently follow the deformation of the current collector, especially on the inner circumferential side of the wound electrode assembly where the degree of deformation of the positive electrode is large, and this seems to cause defects such as cracking in the positive electrode material mixture layer.

Therefore, with a lithium secondary battery positive electrode (hereinafter, also simply referred to as a “positive electrode”) of the present invention, a tetrafluoroethylene-vinylidene fluoride copolymer (hereinafter, referred to as “P(TFE-VDF)”) other than a PVDF-based polymer is used together with PVDF as the binder for the positive electrode material mixture layer, and the total amount of the binder and the usage ratios of PVDF and P(TFE-VDF) are specified. This has enabled the optimal suppression of the adhesion between the positive electrode material mixture layer and the current collector, while using a lithium-containing composite oxide having a high Ni ratio as the positive electrode active material, thereby ensuring good flexibility and high flexural strength. Accordingly, with a lithium secondary battery using a positive electrode of the present invention (i.e., a lithium secondary battery of the present invention), the occurrence of defects such as cracking in the positive electrode material mixture layer can be well suppressed even on the inner circumferential side of a wound electrode assembly including the positive electrode, and therefore it is possible to well suppress the decrease in the battery reliability, such as the capacity decrease. That is, the lithium secondary battery of the present invention is highly reliable, and also has good productivity since it can reduce the proportion of batteries with low reliability when produced in a large quantity.

### Lithium Secondary Battery Positive Electrode of the Present Invention

First, a positive electrode of the present invention will be described. The positive electrode of the present invention includes a positive electrode material mixture layer containing a positive electrode active material, a conductivity enhancing agent and a binder on one or both sides of a current collector, and the positive electrode active material contains a lithium-containing composite oxide represented by the following general formula (1).

General compositional formula: Li₁₊ₓMO₂ (1)

In the above general compositional formula, x is in the range of −0.15≦x≦0.15, M represents an element group of three or more elements including at least Ni, Co and Mn, and the ratios of Ni, Co and Mn to the total elements constituting M satisfy 50≦a≦90, 5≦b≦30, 5≦c≦30, and 10≦b+c≦50 where the ratios of Ni, Co and Mn are represented by a, b and c, respectively, in units of mol %.

The binder contains a tetrafluoroethylene-vinylidene fluoride copolymer and polyvinylidene fluoride, the total content of the binder in the positive electrode material mixture layer is 1 to 4 mass %, and the ratio of the tetrafluoroethylene-vinylidene fluoride copolymer is 10 mass % or more, when the total of the tetrafluoroethylene-vinylidene fluoride copolymer and the polyvinylidene fluoride is taken as 100 mass %.

The lithium-containing composite oxide of the positive electrode according to the present invention contains an element group M including at least Ni, Co and Mn. Ni is a component that contributes to improving the capacity of the lithium-containing composite oxide.

From the viewpoint of improving the capacity of the lithium-containing composite oxide, the ratio a of Ni is 50 mol % or more, when the total amount of elements of the element group M in the general compositional formula (1), representing the lithium-containing composite oxide, is taken as 100 mol %. However, if the ratio of Ni in the element group M is too large, for example, the amounts of Co and Mn will be small, reducing the effects of these elements. Accordingly, the ratio a of Ni is 90 mol % or less, when the total amount of elements of the element group M in the general compositional formula (1), representing the lithium-containing composite oxide, is taken as 100 mol %.

The electrical conductivity of the lithium-containing composite oxide decreases as the average valence of Ni decreases. Accordingly, in the lithium-containing composite oxide, the average valence A of Ni measured by the method described below in the following examples is preferably 2.2 to 2.9. This enables stable synthesis even in the atmospheric air, and it is possible to obtain a high capacity lithium-containing composite oxide having further excellent productivity and thermal stability.

Also, it is preferable that in the lithium-containing composite oxide, the valence B of Ni on the surface of the particles measured by the method described below in the following examples is smaller than the average valence A of Ni in the whole lithium-containing composite oxide. That is, it is preferable that B<A. This makes Ni on the surface of the particles inert and suppresses side reactions in the battery, and it is therefore possible to obtain a battery having further excellent charge/discharge cycle characteristics and storage characteristics.

The valence B of Ni on the surface of the particles need only be smaller than the average valence A of Ni in the whole lithium-containing composite oxide, but the average valence A of Ni can vary according to the ratio of Ni in the lithium-containing composite oxide, and thus the preferable range of the valence B of Ni on the surface of the particles varies as well according to the ratio of Ni in the lithium-containing composite oxide. For this reason, it is difficult to specify a preferred range of the valence B of Ni on the surface of the particles, but for example, in the lithium-containing composite oxide, the difference (A−B) between the average valence A of Ni and the valence B of Ni on the surface of the particles is preferably 0.05 or more, and more preferably 0.1 or more. This makes it possible to better ensure the above-described effects obtained by providing the difference between the average valence A of Ni in the lithium-containing composite oxide and the valence B of Ni on the surface of the particles. However, it is difficult to produce a lithium-containing composite oxide with a large difference (A−B), and thus the (A−B) value is preferably 0.5 or less, and more preferably 0.2 or less.

Co contributes to the capacity of the lithium-containing composite oxide and acts to improve the packing density in the positive electrode material mixture layer of the positive electrode, but it may cause increased cost and reduced safety if the amount is too large. Accordingly, the ratio b of Co is 5 mol % or more and 30 mol % or less, when the total amount of elements of the element group M in the general compositional formula (1), representing the lithium-containing composite oxide, is taken as 100 mol %.

From the viewpoint of increasing the capacity of the lithium-containing composite oxide, the average valence C of Co in the lithium-containing composite oxide, which is measured by the method described below in the following examples, is preferably 2.5 to 3.2.

It is preferable that in the lithium-containing composite oxide, the valence D of Co on the surface of the particles, measured by the method described in the following examples, is smaller than the average valence C of Co in the whole lithium-containing composite oxide. In other words, it is preferable that D<C. As described above, when the valence of Co on the surface of the particles is smaller than the average valence of Co in the whole lithium-containing composite oxide, Li sufficiently diffuses on the surface of the particles, and thus good electrochemical characteristics can be ensured, making it possible to obtain a battery having excellent battery characteristics.

The valence D of Co on the surface of the particles need only be smaller than the average valence C of Co in the whole lithium-containing composite oxide, but the average valence C of Co can vary according to the ratio of Co in the lithium-containing composite oxide. Thus, the preferable range of the valence D of Co on the surface of the particles varies as well according to the ratio of Co in the lithium-containing composite oxide. For this reason, it is difficult to specify a preferred range of the valence D of Co on the surface of the particles. However, for example, in the lithium-containing composite oxide, the difference (C−D) between the average valence C of Co and the valence D of Co on the surface of the particles is preferably 0.05 or more, and more preferably 0.1 or more. This makes it possible to better ensure the above-described effects obtained by providing the difference between the average valence C of Co in the whole lithium-containing composite oxide and the valence D of Co on the surface of the particles. However, it is difficult to produce a lithium-containing composite oxide with a large difference (C−D), and thus the (C−D) value is preferably 0.5 or less, and more preferably 0.2 or less.

In the lithium-containing composite oxide, the ratio c of Mn is 5 mol % or more and 30 mol % or less, when the total amount of elements of the element group M in the general compositional formula (1) is taken as 100 mol %. By including Mn in the above-described amount in the lithium-containing composite oxide so as to have Mn necessarily present in a crystal lattice, the thermal stability of the lithium-containing composite oxide can be increased, thus making it possible to obtain an even safer battery. In other words, Mn stabilizes the layer structure together with divalent Ni in the crystal lattice, improving the thermal stability of the lithium-containing composite oxide.

Furthermore, in the lithium-containing composite oxide, inclusion of Co suppresses variations of Mn valence associated with doping and dedoping of Li during battery charge/discharge and stabilizes the average Mn valence at a value near 4, further increasing reversibility in charge/discharge. Accordingly, by using such a lithium-containing composite oxide, it is possible to obtain a positive electrode that can form a battery having even more excellent charge/discharge cycle characteristics.

The specific average valence of Mn in the lithium-containing composite oxide, which is measured by the method described below in the following examples, is preferably 3.5 to 4.2 in order to stabilize the layer structure together with divalent Ni.

It is preferable that the valence of Mn on the surface of the particles of the lithium-containing composite oxide is equal to the average valence of Mn in the whole particles. This is because in this case, leaching of Mn, which may occur when the valence of Mn on the surface of the particles is low, can be well suppressed.

In the lithium-containing composite oxide, from the viewpoint of better ensuring the effects obtained by combined use of Co and Mn, the sum (b+c) of the ratio b of Co and the ratio c of Mn is 10 mol % or more and 50 mol % or less, when the total amount of elements of the element group M in the general compositional formula (1) is taken as 100 mol %.

The element group M in the general compositional formula (1) representing the lithium-containing composite oxide may contain an element other than Ni, Co and Mn, such as Ti, Cr, Fe, Cu, Zn, Al, Ge, Sn, Mg, Ag, Ta, Nb, B, P and Zr. However, in order to obtain sufficient effects of the present invention, the ratio of the element other than Ni, Co and Mn is preferably 15 mol % or less, and more preferably 3 mol % or less, when the total amount of elements of the element group M is taken as 100 mol %. The element other than Ni, Co and Mn of the element group M may be uniformly distributed in the lithium-containing composite oxide, or may be segregated to the particle surface or the like.

In the general compositional formula (1) representing the lithium-containing composite oxide, when the ratio b of Co and the ratio c of Mn in the element group M satisfy the relationship: b>c, the growth of the lithium-containing composite oxide particles is promoted, and the packing density of the positive electrode in a positive electrode material mixture layer is increased, making it possible to obtain a lithium-containing composite oxide having higher reversibility. Accordingly, a further increase in the capacity of the battery using such a positive electrode is expected.

On the other hand, in the general compositional formula (1) representing the lithium-containing composite oxide, when the ratio b of Co and the ratio c of Mn in the element group M satisfy the relationship: b≦c, a lithium-containing composite oxide having higher thermal stability can be obtained, and a further increase in the safety of the battery using such an electrode is expected.

The lithium-containing composite oxide having the above-described composition has a true density as large as 4.55 to 4.95 g/cm³, and thus is a material having a high volume energy density. This is presumably because the true density of the lithium-containing composite oxide containing Mn within a predetermined range changes significantly according to the composition of the lithium-containing composite oxide, but when the composition is within a narrow composition range as described above, the structure is stabilized and homogeneity is increased, and thus the true density takes a large value close to, for example, the true density of LiCoO₂. Since the lithium-containing composite has a large true density as described above, the capacity of the lithium-containing composite oxide per mass can be increased, and a material having excellent reversibility can be obtained.

The lithium-containing composite oxide has a large true density particularly when it has a composition close to the stoichiometric ratio. Specifically, in the general compositional formula (1), x preferably is within the range of −0.15≦x≦0.15. By adjusting the value of x within this range, it is possible to increase the true density and the reversibility. More preferably, x is −0.05 or more and 0.05 or less. In this case, the lithium-containing composite oxide can have a true density as high as 4.6 g/cm³ or more.

The lithium-containing composite oxide of the positive electrode according to the present invention is preferably a composite oxide represented by the following general compositional formula (2):

Li₁₊ₓNi_{1-d-e}Co_{d}MnₑO₂ (2)

In the above general compositional formula (2), −0.15≦x≦0.15, 0.05≦d≦0.3, 0.05≦e≦0.3, and 0.1≦d+e≦0.5.

In the lithium-containing composite oxide, it is preferable that the ratio of primary particles having a particle size of 1 μm or less to the total primary particles of the lithium-containing composite oxide is preferably 30 vol % or less, and more preferably 15 vol % or less. The lithium-containing composite oxide particles preferably have a BET specific surface area of 0.3 m²/g or less, and more preferably 0.25 m²/g or less. When the lithium-containing composite oxide has such a configuration, the surface activity of the particles can be optimally suppressed. Accordingly, in a battery using this lithium-containing composite oxide as a positive electrode active material, it is possible to suppress the generation of gas and reduce the deformation of the outer case member particularly when the battery has a prismatic outer case member, further improving the storage properties and the service life.

In other words, in the lithium-containing composite oxide, if the ratio of primary particles having a particle size of 1 μm or less to the total primary particles is too large, or if the BET specific surface area is too large, the reaction area will be large, increasing the number of active sites. Thus, the lithium-containing composite oxide can easily cause irreversible reactions with water in the atmospheric air, with the binder used to form a positive electrode material mixture layer of a positive electrode using the lithium-containing composite oxide as an active material, or with the non-aqueous electrolyte in the battery including the positive electrode. As a result, problems are likely to occur such as the outer case member being deformed due to gas generated within the battery, and the composition (paste, slurry or the like) containing a solvent used to form the positive electrode material mixture layer being gelled.

The lithium-containing composite oxide may contain no primary particles having a particle size of 1 μm or less. In other words, the ratio of primary particles having a particle size of 1 μm or less may be 0 vol %. The BET specific surface area of the lithium-containing composite oxide is preferably 0.1 m²/g or more in order to prevent the reactivity from decreasing more than necessary. Furthermore, the lithium-containing composite oxide preferably has a number average particle size of 5 to 25 μm.

The ratio of primary particles having a particle size of 1 μm or less contained in the lithium-containing composite oxide, the number average particle size of the lithium-containing composite oxide and the number average particle size of another active material, which will be described later, can be measured by using a laser diffraction/scattering particle size distribution analyzer such as Microtrac HRA available from Nikkiso Co. Ltd. The BET specific surface area of the lithium-containing composite oxide is a specific surface area of the surface and micropores of the active material obtained by measuring the surface area and performing calculation by the BET method, which is a theory for multilayer adsorption. Specifically, the BET specific surface area is a value obtained using a specific surface area measuring apparatus that uses nitrogen adsorption method (Macsorb HM model-1201 available from Mountech Co., Ltd.).

From the viewpoint of increasing the density of the positive electrode material mixture layer of the positive electrode of the present invention that uses the lithium-containing composite oxide as a positive electrode active material to increase the capacity of the positive electrode and hence the battery capacity, the lithium-containing composite oxide preferably has a spherical shape or a substantially spherical shape. With this configuration, when the lithium-containing composite oxide is moved by pressing in a pressing step, details of which will be described later, during production of a positive electrode so as to increase the density of the positive electrode material mixture layer, the particles of the lithium-containing composite oxide are effortlessly moved and smoothly reoriented. It is therefore possible to reduce the pressing load, reducing damage to the current collector caused by pressing, thus further increasing the positive electrode productivity. When the lithium-containing composite oxide has a spherical shape or a substantially spherical shape, the particles can withstand a larger pressing pressure, thus also making it possible to further increase the density of the positive electrode material mixture layer.

Furthermore, it is preferable that the lithium-containing composite oxide has a tap density of 2.4 g/cm³ or more, and more preferably 2.8 g/cm³ or more, from the viewpoint of increasing the filling ability in the positive electrode material mixture layer of the positive electrode of the present invention. It is preferable that the lithium-containing composite oxide has a tap density of 3.8 g/cm³ or less. In other words, the filling ability of the lithium-containing composite oxide in the positive electrode material mixture layer can be increased by forming the lithium-containing composite oxide as particles having a high tap density and having no pores inside the particles or having a small porosity with a surface area ratio of micropores of 1 μm or less of 10% or less, measured by observing the cross section of the particles.

The tap density of the lithium-containing composite oxide is a value determined through the following measurement using Powder Tester Model PT-S available from Hosokawa Micron Corporation. First, particles are filled and leveled off in a 100-cm³ measurement cup, and tapped for 180 seconds while replenishing a volume loss as appropriate. After completion of tapping, excess particles are leveled off with a blade, thereafter, the mass W (g) is measured, and the tap density is determined by the following equation:

Tap density=W/100

Preferably, the lithium-containing composite oxide of the positive electrode of the present invention is produced by a production method including the steps of washing a composite oxide of Li and the element group M and heat treating the washed composite oxide in an oxygen-containing atmosphere.

The composite oxide of Li and the element group M that is used to produce the lithium-containing composite oxide is obtained by baking a raw material compound containing Li and the element group M. It is very difficult to obtain a highly pure composite oxide of Li and the element group M by simply mixing and baking a Li-containing compound, a Ni-containing compound, a Co-containing compound, and a Mn-containing compound. This is presumably because it is difficult to uniformly disperse Ni, Co and Mn during synthesis reaction of the lithium-containing composite oxide as they have a low diffusion speed in solids, making it difficult to uniformly disperse Ni, Co and Mn in the produced lithium-containing composite oxide.

To address this, when synthesizing the composite oxide of Li and the element group M, it is preferable to employ a method in which a composite compound containing at least Ni, Co and Mn as constituent elements and a Li-containing compound are baked. With this method, particles of the lithium-containing composite oxide can be synthesized in high purity relatively easily. Specifically, a composite compound containing Ni, Co and Mn is synthesized first, and the composite compound is baked together with a Li-containing compound. Thereby, Ni, Co and Mn are uniformly distributed during the oxide forming reaction, and a composite oxide of Li and the element group M is synthesized in even higher purity.

The method for synthesizing a composite oxide of Li and the element group M is not limited to the method described above, but it is surmised that the physical properties of the final product of the lithium-containing composite oxide, or in other words, the structure stability, the charge/discharge reversibility, the true density and the like, change significantly depending on through which process the composite oxide was synthesized.

Examples of the composite compound containing at least Ni, Co and Mn include a coprecipitated compound, a hydrothermally synthesized compound, and a mechanically synthesized compound that contain at least Ni, Co and Mn, and a compound obtained by heat treating any of these compounds. It is preferable to use an oxide or hydroxide of Ni, Co and Mn such as Ni_{0.6}Co_{0.2}Mn_{0.2}O, Ni_{0.6}Co_{0.2}Mn_{0.2}(OH)₂, or Ni_{0.6}Co_{0.3}Mn_{0.1}(OH)₂.

In the case of producing a lithium-containing composite oxide containing an element other than Ni, Co and Mn as a part of the element group M (for example, at least one element selected from the group consisting of Ti, Cr, Fe, Cu, Zn, Al, Ge, Sn, Mg, Ag, Ta, Nb, B, P and Zr, which are hereinafter collectively referred to as an “element M”), the lithium-containing composite oxide can be synthesized by mixing and baking a composite compound containing at least Ni, Co and Mn, a Li-containing compound and an element M′-containing compound, but it is preferable to use a composite compound containing at least Ni, Co, Mn and the element M′ instead of the composite compound containing at least Ni, Co and Mn and the element M′-containing compound. The amount ratios of Ni, Co, Mn and M′ in the composite compound may be adjusted as appropriate according to the intended composition of the lithium-containing composite oxide.

As the Li-containing compound that can be used to synthesize the composite oxide of Li and the element group M, various lithium salts can be used. Examples thereof include lithium hydroxide monohydrate, lithium nitrate, lithium carbonate, lithium acetate, lithium bromide, lithium chloride, lithium citrate, lithium fluoride, lithium iodide, lithium lactate, lithium oxalate, lithium phosphate, lithium pyruvate, lithium sulfate and lithium oxide. Among them, it is preferable to use lithium hydroxide monohydrate because it does not generate a gas that causes harm to the environment, such as carbon dioxide, nitrogen oxides or sulfur oxides.

To synthesize the composite oxide of Li and the element group M, first, a composite compound containing at least Ni, Co and Mn (the composite compound may further contain the element M′), a Li-containing compound and optionally an element M′-containing compound are mixed at a ratio substantially equal to the intended composition of the lithium-containing composite oxide. In order to obtain the final product of the lithium-containing composite oxide having a composition close to the stoichiometric ratio, it is preferable to adjust the mixing ratio of the Li-containing compound to the other raw material compounds such that the amount of Li contained in the Li-containing compound is in excess of the total amount of the element group M. The resultant raw material mixture is then baked at, for example, 800 to 1050° C. for 1 to 24 hours, and thereby a composite oxide of Li and the element group M can be obtained.

When baking the raw material mixture, it is preferable to, rather than increasing the temperature to a certain temperature at a time, temporarily heat the raw material mixture to a temperature (for example, 250 to 850° C.) lower than the baking temperature, maintain the temperature for preheating, and then increase the temperature to the baking temperature to proceed the reaction. It is also preferable to maintain the oxygen concentration in the baking environment at a constant level.

This is performed to increase the homogeneity of the generated composite oxide of Li and the element group M and to grow the crystal of the produced composite oxide of Li and the element group M in a stable manner, by causing a composite compound containing at least Ni, Co and Mn (the composite compound may further contain the element M′), a Li-containing compound and optionally an element M′-containing compound to react stepwise because the composition tends to become non-stoichiometric in the production process of the composite oxide of Li and the element group M due to trivalent Ni, which is unstable. In other words, when the temperature is increased to the baking temperature at a time, or when the oxygen concentration in the baking atmosphere decreases in the course of baking, the homogeneity of the composition is likely to be compromised: for example, the composite compound containing at least Ni, Co and Mn (the composite compound may further contain the element M′), the Li-containing compound and optionally the element M′-containing compound are likely to react non-uniformly, and the produced composite oxide of Li and the element group M may easily release Li.

There is no particular limitation on the preheating time, but the preheating time is usually approximately 0.5 to 30 hours.

The atmosphere used to bake the raw material mixture can be an oxygen-containing atmosphere (or in other words, in the atmospheric air), a mixed atmosphere of an inert gas (argon, helium, nitrogen or the like) and an oxygen gas, an oxygen gas atmosphere, or the like. In this case, the oxygen concentration is preferably 15 vol % or more, and more preferably 18 vol % or more. However, from the viewpoint of increasing the productivity of the lithium-containing composite oxide and hence the productivity of the positive electrode while reducing the production cost of the lithium-containing composite oxide, it is more preferable to bake the raw material mixture in an atmospheric air flow.

The gas flow rate used to bake the raw material mixture is preferably 2 dm³/min or more per 100 g of the mixture. If the gas flow rate is too low, or in other words, if the gas flow speed is too slow, the homogeneity of the composition of the composite oxide of Li and the element group M may be compromised. The gas flow rate used to bake the raw material mixture is preferably 5 dm³/min or less per 100 g of the mixture.

In the step of baking the raw material mixture, a dry-mixed mixture may be used, but it is preferable to use a mixture obtained by dispersing the raw material mixture in a solvent such as ethanol to prepare a slurry, mixing the slurry with a planetary ball mill or the like for approximately 30 to 60 minutes, and drying the slurry. With this method, the homogeneity of the synthesized composite oxide of Li and the element group M can be further increased.

Next, the obtained composite oxide of Li and the element group M is washed. This washing step removes impurities and by-products contained in the composite oxide of Li and the element group M. Water or an organic solvent can be used to wash the composite oxide of Li and the element group M. Examples of the organic solvent include alcohols such as methanol, ethanol, isopropanol and ethylene glycol; ketones such as acetone and methyl ethyl ketone; ethers such as diethyl ether, ethyl propyl ether, diisopropylether, dimethoxyethane, diethoxyethane, trimethoxymethane, tetrahydrofuran, 2-methyltetrahydrofuran, tetrahydrofuran derivatives, γ-butyrolactone, dioxolane, dioxolane derivatives and 3-methyl-2-oxazolidinone; esters such as methyl formate, ethyl formate, methyl acetate, ethyl acetate and phosphoric triester; and aprotic organic solvents such as N-methyl-2-pyrrolidone (NMP), ethylene carbonate (EC), propylene carbonate (PC), butylene carbonate (BC), dimethyl carbonate (DMC), diethyl carbonate (DEC), methyl ethyl carbonate (MEC), propylene carbonate derivatives, dimethyl sulfoxide, formamide, dimethylformamide, acetonitrile, nitromethane, sulfolane and 1,3-propane sultone. It is also possible to use an aminimide-based organic solvent, a sulfur-containing organic solvent, a fluorine-containing organic solvent, and the like. Water and the organic solvents listed above may be used alone or in a combination of two or more.

Furthermore, water and the organic solvent used for the above-described washing may contain an additive, examples of which include celluloses such as carboxymethyl cellulose, carboxy methyl ethyl cellulose, methyl cellulose, ethyl cellulose and hydroxypropyl cellulose; saccharides or oligomers thereof, polyacrylic acid-based resins such as polyacrylic acid, polyacrylic acid derivatives (sodium polyacrylate and the like) and acrylic acid-maleic acid copolymer sodium; polyacrylic acid-based rubbers such as polyacrylic acid esters; fluorine-based resins such as polyvinylidene fluoride, polytetrafluoroethylene and polyhexafluoropropylene; and surfactants such as alkyl polyoxyethylene sulfates, alkyl benzene sulfates, alkyl trimethyl ammonium salts, alkyl benzyldimethyl ammonium salts, alkyl dimethylamine oxide, polyoxyethylene alkyl ethers and fatty acid sorbitan esters. These additives are decomposed and polymerized in the heat treating step performed after the washing step, and thus they can be used to control the surface of the lithium-containing composite oxide. Also, an acid or alkali may be added to the water or organic solvent used for the above-described washing. In this case, it is possible to obtain a more functional material that contributes to control of processing conditions as well as to reactions such as decomposition and polymerization of the additive.

It is preferable to pulverize the baked composite oxide of Li and the element group M prior to the above-described washing.

Next, the washed composite oxide of Li and the element group M is subjected to a heat treatment. The heat treatment causes the transition metals within the composite oxide to be reoriented and allows the diffusion of Li within the composite oxide to proceed, thereby stabilizing the valences of the transition metals present in the whole composite oxide and on the surface thereof.

In order to facilitate the diffusion of Li, the heat treatment temperature is preferably 600° C. or more at which the Li-containing compound (for example, lithium carbonate) melts. Also, in order to prevent the decomposition reaction of the composite oxide, the heat treatment temperature is preferably 1000° C. or less. The heat treatment time is preferably 1 to 24 hours. The heat treatment atmosphere is preferably an atmosphere with an oxygen concentration of 18 vol % or more, and the heat treatment may be performed in an atmosphere with an oxygen concentration of 100 vol %.

With such a production method, it is possible to stably produce a lithium-containing composite oxide that can form a battery having excellent charge/discharge cycle characteristics and storage characteristics and that has the above-described composition and valences of elements, the above-described true density, tap density, various configurations (ratio of primary particles having a particle size of 1 μm or less, BET specific surface area, number-average particle diameter, and shape), and a capacity of 150 mAh/g or more (relative to Li metal, in the case of a drive voltage of 2.5 to 4.3 V).

The positive electrode material mixture layer of the positive electrode according to the present invention contains the lithium-containing composite oxide represented by the general formula (1) as the positive electrode active material, but it may contain an active material other than the lithium-containing composite oxide. Examples of the active material other than the lithium-containing composite oxide include lithium cobalt oxides such as LiCoO₂; lithium manganese oxides such as LiMnO₂ and Li₂MnO₃; lithium nickel oxides such as LiNiO₂; layer-structured lithium-containing composite oxides such as LiCo₁₋ₓNiO₂; spinel-structured lithium-containing composite oxides such as LiMn₂O₄ and Li_{4/3}Ti_{5/3}O₄; olivine-structured lithium-containing composite oxides such as LiFePO₄; and the above-listed oxides partially substituted with various elements. In the case of using another active material, the ratio of the other active material is desirably 30 mass % or less of the entire active material in order to clarify the effects of the present invention.

As the lithium cobalt oxide used as another active material, it is preferable to use, in addition to LiCoO₂ mentioned above, oxides obtained by substituting a part of Co of LiCoO₂ with at least one element selected from the group consisting of Ti, Cr, Fe, Ni, Mn, Cu, Zn, Al, Ge, Sn, Mg and Zr (excluding the lithium-containing composite oxides represented by the general formulas (1) and (2)). The reason for this is that these lithium cobalt oxides have a high conductivity of 1.0×10⁻³ S·cm⁻¹ or more and can further increase the load characteristics of the electrode.

As the spinel-structured lithium-containing composite oxide used as another active material, in addition to LiMn₂O₄ and Li_{4/3}Ti_{5/3}O₄ mentioned above, it is preferable to use oxides obtained by substituting a part of Mn of LiMn₂O₄ with at least one element selected from the group consisting of Ti, Cr, Fe, Ni, Co, Cu, Zn, Al, Ge, Sn, Mg and Zr (excluding the lithium-containing composite oxides represented by the general formulas (1) and (2)). The reason for this is that these spinel-structured lithium-containing composite oxides are excellent in terms of safety during overcharge and the like and can further increase the battery safety, because the amount of lithium that can be extracted is ½ that of lithium-containing oxides such as lithium cobalt oxide and lithium nickel oxide.

In the case where the lithium-containing composite oxide represented by the general formula (1) is used together with another active material, they may be simply mixed, but it is more preferable to use the active materials as composite particles by integrating the particles of the active materials through granulation or the like. In this case, the packing density of the active materials in the positive electrode material mixture layer is improved, and the contact between active material particles can be further ensured. Accordingly, the capacity and the load characteristics of the battery using the positive electrode of the present invention (the lithium secondary battery of the present invention) can be further increased.

The lithium-containing composite oxide represented by the general formula (1) necessarily contains Mn. In the case of using the composite particles, the lithium-containing cobalt oxide is present on the surface of the lithium-containing composite oxide, and thus Mn and Co leached from the composite particles rapidly deposit on the surface of the composite particles, forming a coating film, thus chemically stabilizing the composite particles. This suppresses decomposition of the non-aqueous electrolyte in the lithium secondary battery that can be caused by the composite particles, as well as further leaching of Mn, and it is therefore possible to form a battery having excellent charge/discharge cycle characteristics and storage characteristics.

When the composite particles are used, it is preferable that the number average particle size of either one of the lithium-containing composite oxide represented by the general formula (1) or another active material is ½ or less the number average particle size of the other. In the case of forming the composite particles by combining particles having a large number average particle size (hereinafter referred to as “large particles”) and particles having a small number average particle size (hereinafter referred to as “small particles”) as described above, the small particles become easily dispersed and fixed around the large particles, and thus composite particles having a more uniform mixing ratio can be formed. Accordingly, non-uniform reactions in the electrode can be suppressed, further increasing the charge/discharge cycle characteristics and the safety of the battery.

When forming the composite particles using large particles and small particles, the large particles preferably have a number average particle size of 10 to 30 μm, and the small particles preferably have a number average particle size of 1 to 15 μm.

The composite particles of the lithium-containing composite oxide represented by the general formula (1) and another active material can be obtained by, for example, mixing the particles of the lithium-containing composite oxide represented by the general formula (1) and the particles of the other active material with a commonly-used kneader such as a uniaxial kneader or a biaxial kneader to rub the particles together, and applying a shear force to composite the particles. Kneading is preferably performed by a continuous kneading method that continuously supplies raw material, in consideration of the productivity of the composite particles.

It is preferable to further add a binder to these active material particles when kneading. This makes it possible to keep the shape of the formed composite particles solid. It is more preferable to add a conductivity enhancing agent when kneading. This makes it possible to further increase the conductivity between active material particles.

As the binder and the conductivity enhancing agent added during production of the composite particles, it is possible to use the same binders and conductivity enhancing agents that can be used for a positive electrode material mixture layer described below.

The amount of the binder added when forming the composite particles is preferably as small as possible as long as it is possible to stabilize the composite particles. For example, the amount of the binder is preferably 0.03 to 2 parts by mass per 100 parts by mass of the total active materials.

The amount of the conductivity enhancing agent added when forming the composite particles can be any amount as long as good conductivity and liquid absorbing capabilities can be ensured. For example, the amount of the conductivity enhancing agent is preferably 0.1 to 2 parts by mass per 100 parts by mass of the total active materials.

The composite particles preferably have a porosity of 5 to 15%. The composite particles having such a porosity can be brought into optimal contact with the non-aqueous electrolyte (non-aqueous electrolytic solution), and the non-aqueous electrolyte can optimally permeate into the composite particles.

Furthermore, the composite particles preferably have a spherical shape or a substantially spherical shape as in the case of the lithium-containing composite oxide represented by the general formula (1). This makes it possible to further increase the density of the positive electrode material mixture layer.

As the binder of the positive electrode according to the present invention, P(TFE-VDF) is used together with PVDF. The adhesion between the positive electrode material mixture layer and the current collector can be optimally suppressed by the action of P(TFE-VDF).

As the binder of the positive electrode material mixture layer, another binder can be used together with PVDF and P(TFE-VDF). Examples of such a binder include polyethylene, polypropylene, polytetrafluoroethylene (PTFE), polyhexafluoropropylene (PHFP), styrene butadiene rubber, tetrafluoroethylene-hexafluoroethylene copolymers, tetrafluoroethylene-hexafluoropropylene copolymers (FEP), tetrafluoroethylene-perfluoroalkylvinylether copolymers (PFA), ethylene-tetrafluoroethylene copolymers (ETFE resin), polychlorotrifluoroethylene (PCTFE), propylene-tetrafluoroethylene copolymers, ethylene-chlorotrifluoroethylene copolymer (ECTFE), or ethylene-acrylic acid copolymers, ethylene-methacrylic acid copolymers, ethylene-methyl acrylate copolymers, ethylene-methyl methacrylate copolymers, and Na ion crosslinked structures of these copolymers.

However, in the case of using a binder other than PVDF and P(TFE-VDF), it is preferable that the amount of the other binder used in the positive electrode material mixture layer is 1 mass % or less of the total amount of binder in the positive electrode material mixture layer.

In the positive electrode material mixture layer, the total content of the binder (including the binder contained in the composite particles in the case of using the above-described composite particles as the positive electrode active material; the same applies to the total content of the binder in the positive electrode material mixture layer in the following) is 4 mass % or less, and more preferably 3 mass % or less. The adhesion between the positive electrode material mixture layer and the current collector becomes too high if the amount of the binder in the positive electrode material mixture layer is too large, and therefore defects such as cracking tend to occur in the positive electrode material mixture layer on the inner circumferential side of a wound electrode assembly using the positive electrode.

From the viewpoint of increasing the positive electrode capacity, it is preferable to decrease the amount of the binder in the positive electrode material mixture layer to increase the positive electrode active material content. However, the flexibility of the positive electrode material mixture layer is reduced if the amount of the binder in the positive electrode material mixture layer is too small, and the shape (especially the shape on the outer circumferential side) of a wound electrode assembly using the positive electrode is degraded, which may reduce the productivity of the positive electrode and hence the productivity of the battery using the positive electrode. Therefore, the total content of the binder in the positive electrode material mixture layer is 1 mass % or more, and preferably 1.4 mass % or more.

In the positive electrode material mixture layer, the ratio of P(TFE-VDF) is 10 mass % or more, when the total of PVDF and P(TFE-VDF) is taken as 100 mass %. This makes it possible to optimally suppress the adhesion between the current collector and the positive electrode material mixture layer even if the positive electrode material mixture layer contains PVDF and the lithium-containing composite oxide represented by the general formula (1), which has a high Ni ratio.

However, if the amount of P(TFE-VDF) in the total of PVDF and P(TFE-VDF) is too large, this may lead to a reduction in the adhesion strength of the electrode and an increase in the battery resistance, resulting in a reduction in the load characteristics of the battery. Therefore, the ratio of P(TFE-VDF) is preferably 30 mass % or less, and more preferably 20 mass % or less, when the total of PVDF and P(TFE-VDF) in the positive electrode material mixture layer is taken as 100 mass %.

When the above-described composite particles contain PVDF and P(TFE-VDF), the amount of P(TFE-VDF) in the total of PVDF and P(TFE-VDF) is a value including the amount of PVDF and P(TFE-VDF) contained in the composite particles.

Any conductivity enhancing agent that is chemically stable in a lithium secondary battery may be used as the conductivity enhancing agent of the positive electrode. Examples thereof include: graphites such as natural graphite and artificial graphite; carbon blacks such as acetylene black, Ketjen Black (trade name), channel black, furnace black, lamp black and thermal black; conductive fibers such as carbon fiber and metal fiber; metal powders such as aluminum powder; fluorinated carbon; zinc oxide; conductive whisker made of potassium titanate or the like; conductive metal oxides such as titanium oxide; and organic conductive materials such as polyphenylene derivatives. These may be used alone or in a combination of two or more. Among them, it is preferable to use graphites, which have a high conductivity, or carbon blacks, which have excellent liquid absorbing capabilities. The configuration of the conductivity enhancing agent is not limited to primary particles, and it is also possible to use secondary agglomerates or aggregates such as chain structures. Such aggregates are easier to handle, thus achieving good productivity.

The content of the conductivity enhancing agent (including the conductivity enhancing agent contained in the composite particles) in the positive electrode material mixture layer is preferably 0.5 to 10 mass %.

In the positive electrode material mixture layer, the content of all active materials including the lithium-containing composite oxide represented by the general formula (1) is preferably 80 to 98.5 mass %.

The positive electrode of the present invention can be produced by, for example, forming, on one or both sides of a current collector, a positive electrode material mixture layer including the positive electrode active material containing the lithium-containing composite oxide represented by the general formula (1) serving as an active material, a conductivity enhancing agent, a binder, and so forth.

The positive electrode material mixture layer can be formed by, for example, preparing a positive electrode material mixture-containing composition in the form of a paste or a slurry by adding the positive electrode active material containing the lithium-containing composite oxide represented by the general formula (1) serving as an active material, a conductivity enhancing agent, a binder, and the like to a solvent, and applying the positive electrode material mixture-containing composition onto the surface of a current collector by any application method, drying and pressing the resulting positive electrode material mixture layer to adjust the thickness and density thereof.

The application method used to apply the positive electrode material mixture-containing composition onto the surface of a current collector can be, for example, a substrate withdrawing method using a doctor blade, a coater method using a die coater, a comma coater, a knife coater or the like, a printing method such as screen printing or relief printing.

It is preferable that the positive electrode material mixture layer per side of a current collector after pressing has a thickness of 15 to 200 μm. Furthermore, the positive electrode material mixture layer after pressing preferably has a density of 3.2 g/cm³ or more, and more preferably 3.5 g/cm³ or more. With a positive electrode including such a positive electrode material mixture layer having a high density, it is possible to achieve a further increased capacity. In this respect, the flexibility of the positive electrode material mixture layer of the positive electrode is compromised if the density of the positive electrode material mixture layer is increased. Consequently, in a wound electrode assembly using this positive electrode, defects such as cracking tend to occur in the positive electrode material mixture layer on the inner circumferential side of the wound electrode assembly. However, since the flexibility and the flexural strength of the positive electrode of the present invention have been increased by adopting the above-described configuration, the occurrence of defects in the positive electrode material mixture layer on the inner side of the wound electrode assembly can be favorably suppressed even if the density of the positive electrode material mixture layer is increased as described above.

However, if the density of the positive electrode material mixture layer is too high, the porosity will be low, and the permeability of the non-aqueous electrolyte may decrease. Accordingly, the positive electrode material mixture layer after pressing preferably has a density of 3.8 g/cm³ or less.

Pressing during production of a positive electrode can be performed by, for example, roll pressing at a line pressure of approximately 1 to 100 kN/cm. Through this process, a positive electrode material mixture layer having the above-described density can be obtained.

The density of the positive electrode material mixture layer as used herein refers to a value measured by the following method. First, the positive electrode is cut into a piece having a certain area, the mass of the piece is measured using an electrobalance with a minimum scale value of 0.1 mg, and the mass of the positive electrode material mixture layer is calculated by subtracting the mass of the current collector from the mass of the electrode piece. Meanwhile, the total thickness of the positive electrode is measured at ten points using a micrometer with a minimum scale value of 1 μm, and the volume of the positive electrode material mixture layer is calculated from the area and the average of values obtained by subtracting the current collector thickness from these measured values. Then, the density of the positive electrode material mixture layer is calculated by dividing the mass of the positive electrode material mixture layer by the volume.

There is no particular limitation on the material of the current collector of the positive electrode as long as an electronic conductor that is chemically stable in the formed lithium secondary battery is used. Examples thereof include aluminum, an aluminum alloy, stainless steel, nickel, titanium, carbon and a conductive resin. It is also possible to use a composite material in which a carbon layer or a titanium layer is formed on the surface of aluminum, an aluminum alloy or stainless steel. Among these, it is particularly preferable to use aluminum or an aluminum alloy because of their light weight and high electron conductivity. As the electrode current collector, it is possible to use, for example, a foil, a film, a sheet, a net, a punched sheet, a lath, a porous sheet, a foam, and a molded article formed of fiber bundle that are made of any of the above-listed materials. It is also possible to roughen the current collector surface by surface treatment. There is no particular limitation on the thickness of the current collector, but the thickness is usually 1 to 500 μm.

The positive electrode of the present invention is not limited to a positive electrode produced by the above production method, and may be a positive electrode produced by other methods. In the case of using the composite particles as an active material, the positive electrode of the present invention can be, for example, a positive electrode obtained by a method in which the composite particles are directly fixed to the current collector surface to form a positive electrode material mixture layer, without using the positive electrode material mixture-containing composition.

In the positive electrode of the present invention, a lead connector for electrically connecting to other members within the lithium secondary battery may be formed by a conventional method as needed.

### Lithium Secondary Battery of the Present Invention

Next, a lithium secondary battery of the present invention will be described. The lithium secondary battery of the present invention includes the above-described lithium secondary battery positive electrode of the present invention, a negative electrode, a separator and a non-aqueous electrolyte, and the positive electrode, the negative electrode and the separator form a wound electrode assembly. There is no particular limitation on the configuration and the structure of other elements, and conventionally known configuration and structure employed in non-aqueous secondary batteries can be used.

As the negative electrode, it is possible to use, for example, a negative electrode including a negative electrode material mixture layer made of a negative electrode material mixture containing a negative electrode active material, a binder and optionally a conductivity enhancing agent on one or both sides of a current collector.

Examples of the negative electrode active material include graphite, pyrolytic carbon, coke, glassy carbon, baked products of organic polymer compounds, mesocarbon microbeads, carbon fiber, activated carbon, metals (Si, Sn and the like) capable of forming an alloy with lithium, and alloys thereof. As the binder and the conductivity enhancing agent, it is possible to use any of the binders and conductivity enhancing agents listed above for use in the positive electrode of the present invention.

There is no particular limitation on the material of the negative electrode current collector as long as an electronic conductor that is chemically stable in the formed battery is used. Examples thereof include copper, a copper alloy, stainless steel, nickel, titanium, carbon and a conductive resin. It is also possible to use a composite material in which a carbon layer or a titanium layer is formed on the surface of copper, a copper alloy or stainless steel. Among these, it is particularly preferable to use copper or a copper alloy since they do not form an alloy with lithium, and have high electron conductivity. As the negative electrode current collector, it is possible to use, for example, a foil, a film, a sheet, a net, a punched sheet, a lath, a porous sheet, a foam, and a molded article formed of fiber bundle that are made of any of the above-listed materials. It is also possible to roughen the current collector surface by surface treatment. There is no particular limitation on the thickness of the current collector, but the thickness is usually 1 to 500 μm.

The negative electrode can be obtained by, for example, applying a negative electrode material mixture-containing composition in the form of a paste of a slurry obtained by dispersing a negative electrode material mixture containing a negative electrode active material, a binder and optionally a conductivity enhancing agent in a solvent (the binder may be dissolved in the solvent) on one or both sides of a current collector, and drying the current collector to form a negative electrode material mixture layer. The negative electrode is not limited to a negative electrode obtained by the above-described production method, and may be a negative electrode produced by other methods. The thickness of the negative electrode material mixture layer per side of the current collector is preferably 10 to 300 μm.

The separator is preferably a porous film formed of a polyolefin such as polyethylene, polypropylene or an ethylene-propylene copolymer, a polyester such as polyethylene terephthalate or copolymerized polyester, or the like. The separator preferably has a property that closes the pores at 100 to 140° C. (or in other words, a shutdown function). Accordingly, it is more preferable that the separator contains, as a component, a thermoplastic resin having a melting point of 100 to 140° C., measured using a differential scanning calorimeter (DSC) in accordance with Japanese Industrial Standard (JIS) K 7121. The separator is preferably a monolayer porous film containing polyethylene as a main component, or a laminated porous film constituted of porous films such as a laminated porous film in which two to five layers made of polyethylene and polypropylene are laminated. In the case of mixing polyethylene with a resin having a melting point higher than that of a polyethylene such as polypropylene, or laminating these, it is desirable to use 30 mass % or more of polyethylene, and more desirably 50 mass % or more, as the resin constituting the porous film.

As such a resin porous film, for example, it is possible to use a porous film made of any of the above-listed thermoplastic resins used in conventionally known lithium secondary batteries and the like, or in other words, an ion permeable porous film produced by a solvent extraction method, a dry or wet drawing method, or the like.

The separator preferably has an average pore size of 0.01 μm or more, more preferably 0.05 μm or more, and preferably 1 μm or less, more preferably 0.5 μm or less.

As the characteristics of the separator, it is desirable that the separator has a Gurley value of 10 to 500 sec, measured by the method in accordance with JIS P 8117, the Gurley value indicating the time, expressed in seconds, required for 100 ml of air to pass through a film under pressure of 0.879 g/mm². If the air permeability is too high, the ion permeability will be reduced. If, on the other hand, the permeability is too low, the strength of the separator may be reduced. Furthermore, as the strength of the separator, it is desirable that the separator has a piercing strength of 50 g or more, measured using a needle with a diameter of 1 mm. If the piercing strength is too small, short-circuiting may occur due to the separator being penetrated and broken by formation of lithium dendrite crystals.

Even if the internal temperature of the lithium secondary battery reaches 150° C. or more, the lithium-containing composite oxide represented by the general formula (1) of the positive electrode active material of the present invention has excellent thermal stability, and thus safety can be maintained.

As the non-aqueous electrolyte, a solution (non-aqueous electrolytic solution) in which an electrolyte salt is dissolved in an organic solvent can be used. Examples of the solvent include aprotic organic solvents such as EC, PC, BC, DMC, DEC, MEC, γ-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric triester, trimethoxymethane, dioxolane derivatives, sulfolane, 3-methyl-2-oxazolidinone, propylene carbonate derivatives, tetrahydrofuran derivatives, diethyl ether and 1,3-propane sultone. These may be used alone or in a combination of two or more. It is also possible to use an aminimide-based organic solvent, a sulfur-containing organic solvent, a fluorine-containing organic solvent, or the like. Among them, it is preferable to use a solvent mixture of EC, MEC and DEC. In this case, it is more preferable that DEC is contained in an amount of 15 vol % or more and 80 vol % or less based on the total volume of the solvent mixture. This is because with such a solvent mixture, it is possible to maintain the low-temperature characteristics and the charge/discharge cycle characteristics of the battery at high levels, and enhance the stability of the solvent during high-voltage charging.

As the electrolyte salt used in the non-aqueous electrolyte described above, a lithium perchlorate, an organic boron lithium salt, a salt of a fluorine-containing compound such as trifluoromethane sulfonate, an imide salt, or the like is suitably used. Specific examples of the electrolyte salt include LiClO₄, LiPF₆, LiBF₄, LiAsF₆, LiSbF₆, LiCF₃SO₃, LiC₄F₉SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≦n≦7), and LiN(Rf₃OSO₂)₂, where Rf represents a fluoroalkyl group. These may be used alone or in a combination of two or more. Among them, it is more preferable to use LiPF₆, LiBF₄, or the like because they provide good charge/discharge characteristics. This is because these fluorine-containing organic lithium salts are easily soluble in the above-listed solvents as they have a high anionic character and easily undergo ion separation. There is no particular limitation on the concentration of the electrolyte salt in the solvent, but the concentration is usually 0.5 to 1.7 mol/L.

For the purpose of improving the characteristics such as safety, charge/discharge cycle characteristics and high temperature storage characteristics, an additive such as vinylene carbonate, 1,3-propane sultone, diphenyl disulfide, cyclohexyl benzene, biphenyl, fluorobenzene, or t-butyl benzene can be added to the non-aqueous electrolyte as appropriate. It is particularly preferable to add an additive containing the element sulfur because the surface activity of the active material containing Mn can be stabilized.

The lithium secondary battery of the present invention is formed by, for example, laminating the positive electrode of the present invention and a negative electrode with the above-described separator interposed therebetween and spirally winding the laminate to produce a wound electrode assembly, and enclosing the electrode assembly and the above-described non-aqueous electrolyte in an outer case member by a conventional method. As the form of the battery, the battery can be a cylindrical battery using a cylindrical (circular cylinder or rectangular cylinder) outer case can, a flat battery using a flat (flat circular or flat rectangular as viewed from above) outer case can, a soft package battery using a laminated film having a metal deposited thereon as an outer case member, as in the case of conventionally known lithium secondary batteries. As the outer case can, a steel or aluminum may be used.

The lithium secondary battery of the present invention can be used in the same applications as those of conventional lithium secondary battery, including applications as power sources for various electronic devices including portable electronic devices such as mobile phones and notebook personal computers.

Hereinafter, the present invention will be described in detail by way of examples. It should be noted, however, that the examples given below are not intended to limit the present invention.

### Example 1

### Synthesis of Lithium-Containing Composite Oxide

Ammonia water having a pH adjusted to approximately 12 by addition of sodium hydroxide was placed in a reaction vessel. Under strong stirring, a mixed aqueous solution containing nickel sulfate, cobalt sulfate and manganese sulfate at the respective concentrations of 2.4 mol/dm³, 0.8 mol/dm³ and 0.8 mol/dm³, and ammonia water having a concentration of 25 mass % were added dropwise thereto at rates of 23 cm³/min and 6.6 cm³/min, respectively, using a metering pump, to synthesize a coprecipitated compound (spherical coprecipitated compound) containing Ni, Co and Mn. At this time, the temperature of the reaction solution was held at 50° C., and an aqueous solution of sodium hydroxide having a concentration of 6.4 mol/dm³ was also simultaneously added dropwise such that the pH of the reaction solution was maintained at around 12. Furthermore, a nitrogen gas was bubbled at a flow rate of 1 dm³/min.

The above coprecipitated compound was washed with water, filtrated and dried to give a hydroxide containing Ni, Co and Mn at a molar ratio of 6:2:2. 0.196 mol of the hydroxide and 0.204 mol of LiOH.H₂O were dispersed in ethanol to form a slurry, and the slurry was then mixed for 40 minutes using a planetary ball mill and dried at room temperature to give a mixture. Subsequently, the mixture was placed in an alumina crucible, heated to 600° C. in a dry air flow of 2 dm³/min, held at that temperature for two hours for preheating, and baked for 12 hours by increasing the temperature to 900° C., to synthesize a lithium-containing composite oxide.

The synthesized lithium-containing composite oxide was washed with water, heat treated in the atmospheric air (with an oxygen concentration of approximately 20 vol %) at 850° C. for 12 hours, and then pulverized into powder using a mortar. The pulverized lithium-containing composite oxide was stored in a desiccator.

The lithium-containing composite oxide was analyzed for its composition by an atomic absorption spectrometer, and was found to have a composition represented by Li_{1.02}Ni_{0.60}Cu_{0.20}Mn_{0.20}O₂, (x=0.02, d=0.2, e=0.2 in the general compositional formula (2)).

In order to perform state analysis of the lithium-containing composite oxide, X-ray absorption spectroscopy (XAS) was performed using a BL4 beam port of a compact superconducting radiation source “Aurora (available from Sumitomo Electric Industries, Ltd.)” installed at the SR Center of Ritsumeikan University. The average valence of each of the elements in the whole powder was measured by XAS using a transmission method, and the valence of each of the elements on the powder surface was measured by an electron yield method. The obtained data was analyzed based on Journal of the Electrochemical Society, 146, p 2799-2809 (1999), by using analysis software “REX” available from Rigaku Corporation.

First, in order to determine the average valence of Ni in the whole lithium-containing composite oxide, state analysis similar to that performed on the lithium-containing composite oxide was performed using NiO and LiNi_{0.5}Mn_{1.5}O₄ (standard samples for compounds containing Ni having an average valence of 2) and LiNi_{0.82}Cu_{0.15}Al_{0.03}O₂ (a standard sample for a compound containing Ni having an average valence of 3), and a regression line representing the relationship between the position of the K absorption edge of Ni and the valence of Ni was created for each standard sample.

The state analysis of the lithium-containing composite oxide found, from the position of the K absorption edge of Ni, that the average valence of Ni in the lithium-containing composite oxide was 2.72. Also, the measurement using an electron yield method found, from the position of the K absorption edge of Ni, that the valence of Ni on the powder surface of the lithium-containing composite oxide was 2.57.

The average valence of Co in the whole lithium-containing composite oxide and the valence of Co on the powder surface were determined in the same manner as the average valence of Ni in the whole lithium-containing composite oxide and the valence of Ni on the powder surface after creating a regression line similar to that created for Ni, using CoO (a standard sample for a compound containing Co having an average valence of 2) and LiCoO₂ (a standard sample for a compound containing Co having an average valence of 3).

Furthermore, the average valence of Mn in the whole lithium-containing composite oxide and the valence of Mn on the powder surface were determined in the same manner as the average valence of Ni in the whole lithium-containing composite oxide and the valence of Ni on the powder surface after creating a regression line similar to that created for Ni, using MnO₂ and LiNi_{0.5}Mn_{1.5}O₄ (standard samples for compounds containing Mn having an average valence of 4), LiMn₂O₄ (a standard sample for a compound containing Mn having an average valence of 3.5), LiMnO₂ and Mn₂O₃ (standard samples for compounds containing Mn having an average valence of 3) and MnO (a standard sample for a compound containing Mn having an average valence of 2).

### Production of Positive Electrode

100 parts by mass of the above lithium-containing composite oxide, a solution in which PVDF and P(TFE-VDF) serving as the binder were dissolved in N-methyl-2-pyrrolidone (NMP), 1 part by mass of artificial graphite serving as a conductivity enhancing agent, and 1 part by mass of Ketjen Black were kneaded using a biaxial kneader, and NMP was then added for viscosity adjustment, to prepare a positive electrode material mixture-containing paste.

The amounts of PVDF and P(TFE-VDF) used in the NMP solution were set so that the amounts of PVDF and P(TFE-VDF) dissolved were 2.34 mass % and 0.26 mass %, respectively, of a total of 100 mass % of the lithium-containing composite oxide, PVDF, P(TFE-VDF) and the conductivity enhancing agent (i.e., the total amount of the positive electrode material mixture layer). In other words, in the positive electrode, the total amount of the binder in the positive electrode material mixture layer was 2.6 mass %, and the ratio of P(TFE-VDF) in a total of 100 mass % of P(TFE-VDF) and PVDF was 10 mass %.

The above-described positive electrode material mixture-containing paste was applied to both sides of a 15 μm thick aluminum foil (positive electrode current collector), and then vacuum-dried at 120° C. for 12 hours to form positive electrode material mixture layers on both sides of the aluminum foil. After that, pressing was performed to adjust the thickness and density of the positive electrode material mixture layers. A lead connector made of nickel was welded to an exposed portion of the aluminum foil, and a strip-shaped positive electrode having a length of 375 mm and a width of 43 mm was produced. The positive electrode material mixture layers of the obtained positive electrode had a thickness per side of 55 μm, and had a density of 3.50 g/cm³.

### Production of Negative Electrode

Water was added to 97.5 parts by mass of natural graphite having a number average particle size of 10 μm serving as a negative electrode active material, 1.5 parts by mass of styrene butadiene rubber serving as a binder and 1 part by mass of carboxymethyl cellulose serving as a thickener, and all were mixed to prepare a negative electrode material mixture-containing paste. The negative electrode material mixture-containing paste was applied to both sides of an 8 μm thick copper foil, and then vacuum-dried at 120° C. for 12 hours to form negative electrode material mixture layers on both sides of the copper foil. After that, pressing was performed to adjust the thickness and density of the negative electrode material mixture layers. A lead connector made of nickel was welded to an exposed portion of the copper foil, and a strip-shaped negative electrode having a length of 380 mm and a width of 44 mm was produced. The negative electrode material mixture layers of the obtained negative electrode had a thickness per side of 65 μm.

### Preparation of Non-Aqueous Electrolyte

LiPF₆ was dissolved at a concentration of 1 mol/L in a solvent mixture of EC, MEC and DEC at a volume ratio of 2:3:1, to prepare a non-aqueous electrolyte.

### Assembly of Battery

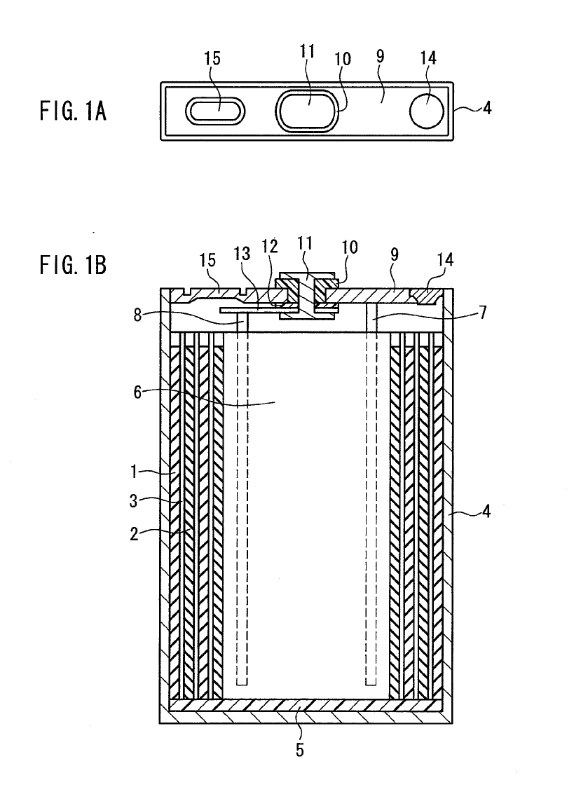

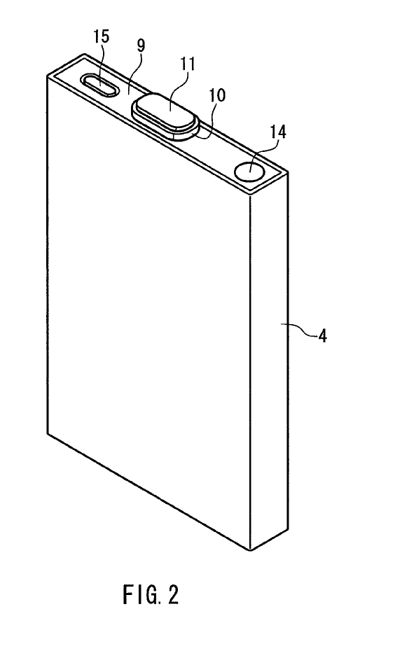

The strip-shaped positive electrode was placed on the strip-shaped negative electrode with a 16 μm thick microporous polyethylene separator (porosity: 41%) interposed therebetween, and these were spirally wound and then pressed into a flat shape to form an electrode assembly having a flat wound structure. The wound electrode assembly was fixed with polypropylene insulation tape. Next, the wound electrode assembly was inserted in a prismatic battery case made of an aluminum alloy having outer dimensions of a thickness of 4.0 mm, a width of 34 mm and a height of 50 mm, lead connectors were welded, and a lid plate made of an aluminum alloy was welded to the opening edge of the battery case. After that, the non-aqueous electrolyte was injected from an inlet provided in the lid plate, and after standing one hour, the inlet was sealed to obtain a lithium secondary battery having the structure shown in FIGS. 1A and 1B and the outer appearance shown in FIG. 2. The designed electrical capacity of the lithium secondary battery was 1000 mAh.

The battery shown in FIGS. 1A, 1B and 2 will be described here. FIG. 1A is a plan view, and FIG. 1B is a cross-sectional view of FIG. 1A. As shown in FIG. 1B, a positive electrode 1 and a negative electrode 2 are spirally wound with a separator 3 interposed therebetween; and then pressed into a flat shape to form a flat wound electrode assembly 6, and the electrode assembly 6 is housed in a rectangular cylindrical battery case 4 together with a non-aqueous electrolyte. In order to simplify the illustration of FIG. 1B, metal foils serving as current collectors used to produce the positive electrode 1 and the negative electrode 2 and the non-aqueous electrolyte are not illustrated.

The battery case 4 is made of an aluminum alloy and constitutes a outer case member of the battery. The battery case 4 also serves as a positive electrode terminal. An insulator 5 made of a polyethylene sheet is placed on the bottom of the battery case 4, and a positive electrode lead connector 7 and a negative electrode lead connector 8 connected to the ends of the positive electrode 1 and the negative electrode 2, respectively, are drawn from the flat wound electrode assembly 6 including the positive electrode 1, the negative electrode 2 and the separator 3. A stainless steel terminal 11 is attached to a sealing lid plate 9 made of an aluminum alloy for sealing the opening of the battery case 4 with a polypropylene insulation packing 10 interposed therebetween, and a stainless steel lead plate 13 is attached to the terminal 11 with an insulator 12 interposed therebetween.

Then, the lid plate 9 is inserted into the opening of the battery case 4, and the joint portions of the lid plate 9 and the battery case 4 are welded to seal the opening of the battery case 4, thus sealing the interior of the battery. In the battery shown in FIGS. 1A and 1B, the lid plate 9 is provided with a non-aqueous electrolyte inlet 14, and the non-aqueous electrolyte inlet 14 is sealed by welding such as laser welding, with a sealing member inserted into the non-aqueous electrolyte inlet 14, and thereby the seal of the battery is ensured. Accordingly, in the battery shown in FIGS. 1A, 1B and 2, the non-aqueous electrolyte inlet 14 actually includes the non-aqueous electrolyte inlet and the sealing member, but in order to simplify the illustration, they are indicated as the non-aqueous electrolyte inlet 14. The lid plate 9 is also provided with a rupture vent 15 serving as a mechanism that discharges internal gas to the outside in the event of overheating of the battery.

In the battery of Example 1, the positive electrode lead connector 7 is welded directly to the lid plate 9, whereby the battery case 4 and the lid plate 9 function as a positive electrode terminal. Likewise, the negative electrode lead connector 8 is welded to the lead plate 13, and the negative electrode lead connector 8 and the terminal 11 are electrically connected via the lead plate 13, whereby the terminal 11 functions as a negative electrode terminal.

FIG. 2 is a perspective view schematically showing the outer appearance of the battery shown in FIG. 1A, and FIG. 2 is illustrated to indicate that the battery is a prismatic battery. FIG. 2 schematically shows the battery, and thus only specific constituent elements of the battery are shown. Similarly, in FIG. 1B, the inner circumferential side of the electrode assembly is not shown in cross section.

### Examples 2 to 8 and Comparative Examples 1 to 3

Lithium secondary batteries were produced in the same manner as in Example 1 except that the total amount of the binder in the positive electrode material mixture layer of the positive electrode and the ratio of P(TFE-VDF) in a total of 100 mass % of P(TFE-VDF) and PVDF were changed as shown in Table 1.

TABLE 1

| | Total amount of | |
|---|---|---|
| | binder in positive | |
| | electrode material | Ratio of P(TFE-VDF) in total of 100 |
| | mixture layer | mass % of P(TFE-VDF) and PVDF |
| | (mass %) | (mass %) |
| Example 1 | 2.6 | 10 |
| Example 2 | 2.6 | 20 |
| Example 3 | 2.6 | 30 |
| Example 4 | 2.6 | 40 |
| Example 5 | 1.4 | 20 |
| Example 6 | 2.0 | 20 |
| Example 7 | 3.2 | 20 |
| Example 8 | 3.8 | 20 |
| Com. Ex. 1 | 2.6 | 0 |
| Com. Ex. 2 | 2.6 | 1 |
| Com. Ex. 3 | 2.6 | 5 |

For the produced lithium secondary batteries of each of Examples 1 to 8 and Comparative Examples 1 to 3, the number of batteries, out of 50 batteries, in which cracking had occurred in the positive electrode material mixture layer on the inner circumferential side of the wound electrode assembly, and the number of batteries, out of 60 batteries, in which the wound electrode assembly could not be successfully inserted into the outer case can due to a shape defect in the outer circumferential portion of the wound electrode assembly were examined.

Furthermore, of the lithium secondary batteries of Example 1 to 8 and Comparative Examples 1 to 3, those batteries in which the wound electrode assembly could be successfully inserted into the outer case can were evaluated for the following load characteristics.

### Evaluation of Load Characteristics

Each of the batteries was subjected to constant current charging at a current value of 1 C until the voltage reached 4.2 V, and then each battery was subjected to constant voltage charging at 4.2 V. The total charging time was 3 hours. Each of the charged batteries was subjected to constant current discharging at a current value of 0.2 C until the voltage reached 3.0 V, and the discharge capacity (0.2 C discharge capacity) was measured. Next, those batteries that could be successfully charged for measuring the 0.2 C discharge capacity (or in other words, those batteries in which cracking did not occur in the positive electrode material mixture layer on the inner circumferential side of the wound electrode assembly) were subjected to charging under the same conditions as described above. Subsequently, the batteries were subjected to constant current discharging at a current value of 2 C until the voltage reached 3.0 V, and the discharge capacity (2 C discharge capacity) was measured. Then, the values obtained by dividing the 2 C discharge capacity by the 0.2 C discharge capacity (2 C/0.2 C discharge capacity ratio) were expressed in percentage for evaluation of the load characteristics. It can be said that the larger the value of the 2 C/0.2 C discharge capacity ratio, the better the load characteristics of the battery.

The results of the above-described evaluations are shown in Table 2.

TABLE 2

| | Number of | | |
|---|---|---|---|
| | batteries in which | Number of batteries | |
| | cracking occurred | in which wound | |
| | in positive | electrode assembly | 2 C/0.2 C |
| | electrode material | was failed to be | discharge |
| | mixture | inserted into outer | capacity |
| | layers/Total | case can/ | ratio |
| | number | Total number | (%) |
| Example 1 | 0/50 | 0/60 | 70 |
| Example 2 | 0/50 | 0/60 | 66 |
| Example 3 | 0/50 | 0/60 | 59 |
| Example 4 | 0/50 | 0/60 | 42 |
| Example 5 | 0/50 | 3/60 | 73 |
| Example 6 | 0/50 | 0/60 | 73 |
| Example 7 | 2/50 | 0/60 | 46 |
| Example 8 | 0/50 | 0/60 | 15 |
| Com. Ex. 1 | 34/50 | 0/60 | 72 |
| Com. Ex. 2 | 14/50 | 0/60 | 71 |
| Com. Ex. 3 | 7/50 | 0/60 | 69 |

As is evident from Table 2, the batteries of Examples 1 to 8, in which P(TFE-VDF) and PVDF were used as the binder for the positive electrode material mixture layer and the total amount of the binder in the positive electrode material mixture layer and the ratio of P(TFE-VDF) in the total amount of P(TFE-VDF) and PVDF were set to optimum values, showed suppressed cracking in the positive electrode material mixture layer on the inner circumferential side of the wound electrode assembly, as compared with the battery of Comparative Example 1, in which only PVDF was used as the binder of the positive electrode material mixture layer, and the batteries of Comparative Examples 2 and 3, in which the ratio of P(TFE-VDF) in a total of 100 mass % of P(TFE-VDF) and PVDF used in the positive electrode material mixture layer was small. The batteries of Examples 1 to 8 also showed well reduced failure in inserting the wound electrode assembly into the outer case can, and therefore had high reliability and productivity.

Furthermore, each of the batteries of Examples 1, 2, 5 and 6, in which the total amount of the binder in the positive electrode material mixture layer was 3 mass % or less and the ratio of P(TFE-VDF) in the total amount of P(TFE-VDF) and PVDF was 20 mass % or less, had good load characteristics, although slightly inferior to those of the battery of Comparative Example 1 in some cases.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A lithium secondary battery positive electrode comprising a positive electrode material mixture layer containing a positive electrode active material, a conductivity enhancing agent and a binder on one or both sides of a current collector,
wherein the positive electrode active material contains a lithium-containing composite oxide represented by the general compositional formula:
Li₁₊ₓMO₂,
where x is in a range of −0.15≦x≦0.15 and M represents an element group of three or more elements including at least Ni, Co and Mn,
the ratios of Ni, Co and Mn to the total elements constituting M satisfy 50≦a≦90, 5≦b≦30, 5≦c≦30, and 10≦b+c≦50 where the ratios of Ni, Co and Mn are represented by a, b and c, respectively, in units of mol %,
the binder contains a tetrafluoroethylene-vinylidene fluoride copolymer and polyvinylidene fluoride,
the total content of the binder in the positive electrode material mixture layer is 1 to 4 mass %, and
the ratio of the tetrafluoroethylene-vinylidene fluoride copolymer is 10 mass % or more, when the total of the tetrafluoroethylene-vinylidene fluoride copolymer and the polyvinylidene fluoride is taken as 100 mass %.

2. The lithium secondary battery positive electrode according to claim 1, wherein the ratio of the tetrafluoroethylene-vinylidene fluoride copolymer is 30 mass % or less, when the total of the tetrafluoroethylene-vinylidene fluoride copolymer and the polyvinylidene fluoride is taken as 100 mass %.

3. The lithium secondary battery positive electrode according to claim 1, wherein the positive electrode material mixture layer has a density of 3.2 g/cm³ or more.

4. The lithium secondary battery positive electrode according to claim 1, wherein the positive electrode material mixture layer has a density of 3.8 g/cm³ or less.

5. The lithium secondary battery positive electrode according to claim 1, wherein the average valence A of Ni in the whole lithium-containing composite oxide is 2.2 to 2.9, and the valence B of Ni on the surface of particles of the lithium-containing composite oxide satisfies the relationship: B<A.

6. The lithium secondary battery positive electrode according to claim 1, wherein the average valence C of Co in the whole lithium-containing composite oxide is 2.5 to 3.2, and the valence D of Co on the surface of particles of the lithium-containing composite oxide satisfies the relationship: D<C.

7. The lithium secondary battery positive electrode according to claim 1, wherein the average valence of Mn in the whole lithium-containing composite oxide is 3.5 to 4.2.

8. The lithium secondary battery positive electrode according to claim 1, wherein the ratio b of Co and the ratio c of Mn satisfy the relationship: b>c.

9. The lithium secondary battery positive electrode according to claim 1, wherein the ratio b of Co and the ratio c of Mn satisfy the relationship: b≦c.

10. The lithium secondary battery positive electrode according to claim 1, wherein the lithium-containing composite oxide is represented by the general compositional formula: Li₁₊ₓNi_{1-d-e}Co_{d}MnₑO₂, and −0.15≦x≦0.15, 0.05≦d≦0.3, 0.05≦e≦0.3 and 0.1≦d+e≦0.5.

11. A lithium secondary battery comprising a positive electrode, a negative electrode, a separator and a non-aqueous electrolyte,
wherein the positive electrode, the negative electrode and the separator form a wound electrode assembly,
the positive electrode comprises a positive electrode material mixture layer containing a positive electrode active material, a conductivity enhancing agent and a binder on one or both sides of a current collector,
the positive electrode active material contains a lithium-containing composite oxide represented by the general compositional formula:
Li₁₊ₓMO₂,
where x is in a range of −0.15≦x≦0.15 and M represents an element group of three or more elements including at least Ni, Co and Mn,
the ratios of Ni, Co and Mn to the total elements constituting M satisfy 50≦a≦90, 5≦b≦30, 5≦c≦30, and 10≦b+c≦50 where the ratios of Ni, Co and Mn are represented by a, b and c, respectively, in units of mol %,
the binder contains a tetrafluoroethylene-vinylidene fluoride copolymer and polyvinylidene fluoride,
the total content of the binder in the positive electrode material mixture layer is 1 to 4 mass %, and
the ratio of the tetrafluoroethylene-vinylidene fluoride copolymer is 10 mass % or more, when the total of the tetrafluoroethylene-vinylidene fluoride copolymer and the polyvinylidene fluoride is taken as 100 mass %.

12. The lithium secondary battery according to claim 11, wherein the ratio of the tetrafluoroethylene-vinylidene fluoride copolymer is 30 mass % or less, when the total of the tetrafluoroethylene-vinylidene fluoride copolymer and the polyvinylidene fluoride is taken as 100 mass %.

13. The lithium secondary battery according to claim 11, wherein the positive electrode material mixture layer has a density of 3.2 g/cm³ or more.

14. The lithium secondary battery according to claim 11, wherein the positive electrode material mixture layer has a density of 3.8 g/cm³ or less.

15. The lithium secondary battery according to claim 11, wherein the average valence A of Ni in the whole lithium-containing composite oxide is 2.2 to 2.9, and the valence B of Ni on the surface of particles of the lithium-containing composite oxide satisfies the relationship: B<A.

16. The lithium secondary battery according to claim 11, wherein the average valence C of Co in the whole lithium-containing composite oxide is 2.5 to 3.2, and the valence D of Co on the surface of particles of the lithium-containing composite oxide satisfies the relationship: D<C.

17. The lithium secondary battery according to claim 11, wherein the average valence of Mn in the whole lithium-containing composite oxide is 3.5 to 4.2.

18. The lithium secondary battery according to claim 11, wherein the ratio b of Co and the ratio c of Mn satisfy the relationship: b>c.

19. The lithium secondary battery according to claim 11, wherein the ratio b of Co and the ratio c of Mn satisfy the relationship: b≦c.

20. The lithium secondary battery according to claim 11, wherein the lithium-containing composite oxide is represented by the general compositional formula: Li₁₊ₓNi_{1-d-e}Co_{d}MnₑO₂, and −0.15≦x≦0.15, 0.05≦d≦0.3, 0.05≦e≦0.3 and 0.1≦d+e≦0.5.
